(19) United States
(12) Patent Application Publication
(10) Pub. No.: US 2024/0329496 A1
(43) Pub. Date: Oct. 3, 2024

(54) IMAGING DEVICE

(71) Applicant: Panasonic Automotive Systems Co., Ltd., Kanagawa (JP)

(72) Inventors: Eiji NAGASAKI, Osaka (JP); Satoru MACHIDA, Kanagawa (JP); Kenji NAGATOMI, Osaka (JP)

(21) Appl. No.: 18/742,868

(22) Filed: Jun. 13, 2024

Related U.S. Application Data
(63) Continuation of application No. PCT/JP2022/041994, filed on Nov. 10, 2022.

(30) Foreign Application Priority Data
Dec. 27, 2021 (JP) 2021-212912

(51) Int. Cl. G03B 17/08; G03B 30/00

(52) U.S. Cl. CPC G03B 17/08; G03B 30/00

(57) ABSTRACT

An imaging device according to an embodiment includes a lens barrel, a board, a housing, and an adhesive member. A lens is arranged in the lens barrel. An imaging element is mounted on the board, the imaging element converting light received through the lens into an image signal. The housing houses the board, and includes a hole at a position that faces the imaging element, one end side of the lens barrel being fitted into the hole. The adhesive member is provided between an outer peripheral surface of the lens barrel and an inner peripheral surface of the hole, in a state where the one end side of the lens barrel is fitted into the hole, and the adhesive member fixes the lens barrel to the housing.

### CROSS-REFERENCE TO RELATED APPLICATIONS

This application is a continuation of International Application No. PCT/JP2022/041994, filed on Nov. 10, 2022 which claims the benefit of priority of the prior Japanese Patent Application No. 2021-212912, filed on Dec. 27, 2021, the entire contents of which are incorporated herein by reference.

### FIELD

Embodiments described herein relate generally to an imaging device.

### BACKGROUND

In recent years, the equipping of a camera (hereinafter, also referred to as an imaging device) in a vehicle has been increasing in accordance with the spread of a driving assistance system of the vehicle. Such an imaging device includes a lens barrel, to which a lens has been attached, and a housing that houses an image sensor (hereinafter, also referred to as a sensor) etc.

Incidentally, the imaging device described above is used in a variety of environments such as exposure to vibration of the vehicle and installation outside the vehicle, but clear images can be obtained over a long period of time by maintaining an appropriate positional relationship between the lens and the housing. For example, conventionally, an adhesive has been applied to a portion where the lens barrel and the housing come into contact with each other in an optical axis direction of the lens barrel to fix the lens barrel to the housing (for example, JP 6739506 B2).

However, it is known that deviation occurs in a positional relationship between the lens barrel and the housing due to a variety of factors. For example, in the technique described above for applying an adhesive to a contact portion in the optical axis direction between the lens barrel and the housing to fix the lens barrel to the housing, if the adhesive absorbs liquid, such as raindrops, generated in a variety of environments (for example, high temperature and humidity) and the adhesive is expanded, there is a possibility that the positional relationship between the lens barrel and the housing shifts in the optical axis direction to cause deviation.

If deviation occurs in the positional relationship between the lens barrel and the housing, the quality of an image captured by the imaging device deteriorates, and therefore there is a request for a technique that enables an appropriate positional relationship to be maintained between the lens barrel and the housing.

The present disclosure provides an imaging device that is capable of maintaining an appropriate positional relationship between a lens barrel and a housing.

### SUMMARY

An imaging device according to an embodiment of the present disclosure includes: a lens barrel in which a lens is arranged; a board on which an imaging element is mounted, the imaging element converting light received through the lens into an image signal; a housing that houses the board, the housing including a hole at a position that faces the imaging element, one end side of the lens barrel being fitted into the hole; and an adhesive member that is provided between an outer peripheral surface of the lens barrel and an inner peripheral surface of the hole, in a state where the one end side of the lens barrel is fitted into the hole, the adhesive member fixing the lens barrel to the housing.

### BRIEF DESCRIPTION OF THE DRAWINGS

FIG. 1 is a perspective view illustrating an example of an imaging device according to an embodiment;

FIG. 2 is an exploded view illustrating the example of the imaging device according to the embodiment;

FIG. 3 is a sectional view illustrating the example of the imaging device according to the embodiment; and

FIG. 4 is a sectional view illustrating an example of an imaging device in a conventional example.

### DETAILED DESCRIPTION

Hereinafter, an embodiment of the present disclosure will be described in detail with reference to the drawings as appropriate. Note that the attached drawings and the description below are provided to make the present disclosure sufficiently understandable to those skilled in the art, and these are not intended to limit the subject matter described in the claims.

An imaging device according to the present embodiment is, for example, an in-vehicle camera that is equipped in a vehicle and can be used for driving assistance for the vehicle. The imaging device for driving assistance plays a principal role in a driving assistance system of the vehicle such that an image signal processor (ISP) inside the imaging device performs image processing to detect an object such as another vehicle, a pedestrian, or an obstacle, and, for example, the warning is given to a driver or the vehicle is forcibly stopped.

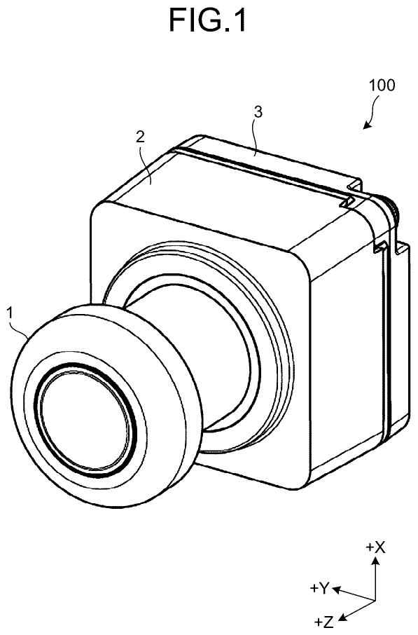

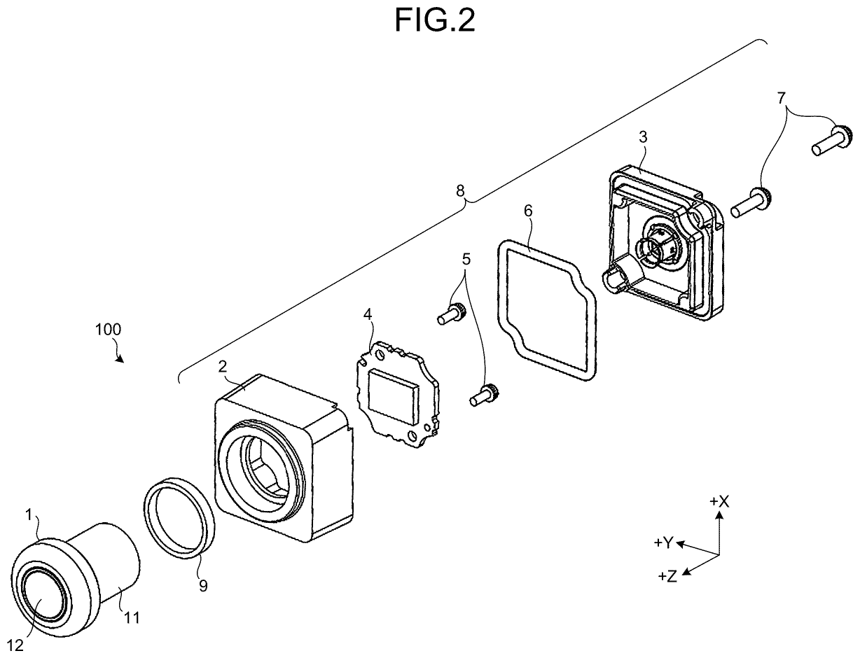

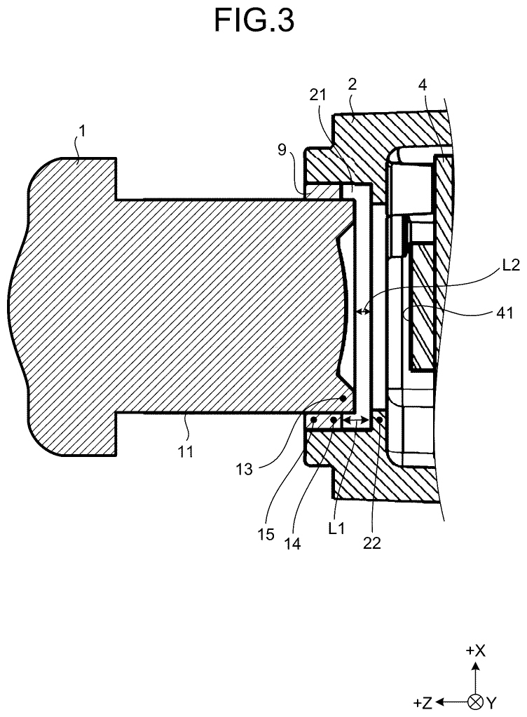

An example of a configuration of the imaging device according to the present embodiment is described with reference to FIGS. 1, 2, and 3. FIG. 1 is a perspective view of the imaging device according to the embodiment. FIG. 2 is an exploded view of the imaging device according to the embodiment. FIG. 3 is a sectional view of the imaging device according to the embodiment.

Note that in the drawings described below, for convenience's sake, an X-axis, a Y-axis, and a Z-axis that are orthogonal to each other are illustrated, and an upward/downward direction (an X-direction), a leftward/rightward direction (a Y-direction), and a forward/backward direction (a Z-direction) in an imaging device 100 according to the embodiment are described by using the X-axis, the Y-axis, and the Z-axis. Note that in the description below, in a case where the expression “X-direction”, “Y-direction”, or “Z-direction” is simply used, two directions that are each of the axis directions and are opposite to each other are covered.

Furthermore, in a case where a direction is specified as a positive direction of the X-axis, the direction refers to a single direction from a lower side to an upper side. In a case where a direction is specified as a positive direction of the Y-axis, the direction refers to a single direction from a right-hand side to a left-hand side. In a case where a direction is specified as a positive direction of the Z-axis, the direction refers to a single direction from a rear side to a front side. In a case where a direction is specified as a negative direction of the X-axis, the direction refers to a single direction from the upper side to the lower side. In a case where a direction is specified as a negative direction of the Y-axis, the direction refers to a single direction from the left-hand side to the right-hand side. In a case where a direction is specified as a negative direction of the Z-axis, the direction refers to a single direction from the front side to the rear side.

The imaging device 100 according to the present embodiment includes a lens unit 1, a first housing 2, a second housing 3, a board 4, a first fixing member 5, a waterproof member 6, a second fixing member 7, and an adhesive member 9. Hereinafter, a structural body formed by attaching the second housing 3 to the first housing 2 is also referred to as a housing 8.

The lens unit 1 includes a lens barrel 11 and a lens 12. The lens barrel 11 is a member that is open at both ends, and has a cylindrical shape. Inside the lens barrel 11, the lens 12 is arranged at a predetermined position. The lens barrel 11 is fitted into a hole 21 described later in a state where the end 13 described later on one end side of the lens barrel 11 is separated from the housing 8. The lens barrel 11 can be formed by using, for example, a metal material such as aluminum.

The lens 12 is formed by using plastic, glass, or the like. The lens 12 is arranged along an optical axis (in a Z-axis direction) inside the lens barrel 11, and forms an image of light from a subject on an imaging element 41 described later that has been mounted on the board 4. Note that a single lens 12 may be employed, or a plurality of lenses 12 may be employed.

The first housing 2 is an example of a housing. The first housing 2 has a recessed shape that is inwardly recessed. The first housing 2 houses a portion of the lens unit 1 and the board 4 described later inside a space formed by combining the first housing 2 with the second housing 3 described later. The lens unit 1 is attached to the first housing 2. The first housing 2 includes the hole 21, into which one end side of the lens barrel 11 is fitted, at a position that faces the imaging element 41. Stated another way, on a face of the first housing 2 to which the lens barrel 11 is attached, the hole 21 that corresponds to an external form (an external diameter) of the lens barrel 11 is formed.

The lens unit 1 is attached to the first housing 2 by fitting the one end side of the lens barrel 11 into the hole 21 of the first housing 2. The first housing 2 is made of, for example, an aluminum die casting (as an example, an aluminum alloy such as ADC12). Note that the first housing 2 is also referred to as a front case.

Furthermore, a face that is a peripheral edge of the hole 21, and into which the one end side of the lens barrel 11 is fitted is provided with the adhesive member 9 described later that is used to fix the lens unit 1 to the first housing 2. The description relating to the adhesive member 9 will be provided later.

The second housing 3 is an example of the housing. The second housing 3 has a recessed shape that is inwardly recessed. The second housing 3 houses a portion of the lens unit 1 and the board 4 described later inside a space formed by combining the second housing 3 with the first housing 2. The second housing 3 is made of, for example, an aluminum die casting (as an example, aluminum alloy such as ADC). Note that the second housing 3 is also referred to as a rear case.

The second housing 3 includes an output mechanism inside (this is not illustrated). The output mechanism is a conductive connection unit that is used to connect an electric cable that outputs, to the outside, an image signal serving as a signal that has been output from the imaging element 41. The output mechanism is, for example, a coaxial (two-wire type) connector, a shield twist quad wire (STQ) (four-wire type) connector, or a CAN-STQ (six-wire type) connector.

The imaging element 41 that converts light received through the lens 12 into an image signal is mounted on one face side of the board 4. Furthermore, a mounting board connector that includes a connection terminal for the imaging element 41 is mounted on the one face side of the board 4. The board 4 is housed inside a space formed by the first housing 2 and the second housing 3.

The first fixing member 5 is an example of a fixing member. The first fixing member 5 fastens the board 4 to the first housing 2 in a positive direction of the Z-axis direction to fix the board 4 to the first housing 2. The first fixing member 5 is, for example, a fixing screw that is made of a metal material (as an example, metal or stainless steel) or the like.

The waterproof member 6 is a sealing member that is used to keep air-tightness in an internal space of the housing 8. The waterproof member 6 is provided between the first housing 2 and the second housing 3, is interposed between the first housing 2 and the second housing 3, and is pressed in the Z-axis direction. By pressing the waterproof member 6, a joining face between the first housing 2 and the second housing 3 is sealed, and the imaging device 100 has a waterproof function. The waterproof member 6 is, for example, waterproof packing that uses an arbitrary elastic material such as rubber.

The second fixing member 7 is an example of the fixing member. The second fixing member 7 is a fixing member that penetrates the first housing 2 or the second housing 3, and fixes one housing to another housing. The second fixing member 7 fastens the second housing 3 to the first housing 2 in a positive direction of the Z-axis direction to fix the second housing 3 to the first housing 2. The second fixing member 7 is, for example, a fixing screw that is made of a metal material (as an example, metal or stainless steel) or the like.

The adhesive member 9 is an example of an adhesive member. The adhesive member 9 is a member that fixes the housing 8 and the lens barrel 11. Specifically, the adhesive member 9 is provided between an outer peripheral surface of the lens barrel 11 and an inner peripheral surface of the hole 21 in a state where the one end side of the lens barrel 11 has been fitted into the hole 21, and the adhesive member 9 fixes the lens barrel 11 to the housing 8. Furthermore, the adhesive member 9 is provided in a portion where the outer peripheral surface of the lens barrel 11 faces the inner peripheral surface of the hole 21. Moreover, the adhesive member 9 is provided in a circumferential direction of the lens barrel 11.

The adhesive member 9 has, for example, a property of being cured as a result of heat treatment or ultraviolet (UV) irradiation. Furthermore, the adhesive member 9 may have, for example, a property of being temporarily cured as a result of UV irradiation prior to principal curing as a result of heat treatment. Hereinafter, temporary curing using UV irradiation is referred to as first curing, and principal curing using heat treatment is referred to as second curing. The adhesive member 9 according to the present embodiment has a characteristic of being cured after two stages of processes, first curing using UV irradiation and second curing using heat treatment.

The adhesive member 9 that is cured after such two stages of processes can be implemented by, for example, an adhesive including epoxy resin. By performing first curing using UV irradiation, the lens barrel 11 that has been attached to the housing 8 can be prevented from being displaced before second curing using heat treatment, and the lens unit 1 can be precisely attached to the housing 8.

Furthermore, it is preferable that a water absorption rate of the adhesive member 9 be 0.5% or less. If the water absorption rate of the adhesive member 9 is 0.5% or less, even if water absorption has caused the adhesive member 9 to expand, a degree of being out of focus due to a shift in a positional relationship between the lens barrel 11 and the housing 8 can fall within a certain allowable range, and a significant deterioration of an image can be avoided.

Here, a method for attaching the lens unit 1 is described.

First, an adhesive is applied to a portion to which the lens unit 1 will be attached in the first housing 2.

Next, the lens unit 1 is fitted into the hole 21 in a state where the end 13 on one end side of the lens barrel 11 is separated from the housing 8. Specifically, the lens unit 1 is fitted into the hole 21 in such a way that a second clearance L2 is kept between the end 13 on the one end side of the lens barrel 11 to be fitted into the hole 21 and the housing 8 serving as a bottom 22 of the hole 21. The diameter of the bottom 22 is smaller than the diameter of the hole 21. Note that the second clearance L2 is smaller than a first clearance L1.

Here, the adhesive is applied between an outer peripheral surface of the lens unit 1 and the inner peripheral surface of the hole 21, as illustrated in FIG. 3. Specifically, the adhesive is applied to a portion where an outer peripheral surface on the one end side of the lens barrel 11 to be fitted into the hole 21 faces the inner peripheral surface of the hole 21. As a result of this, the first clearance L1 is kept between an end (a bottom face) 14 on a side of the board 4 of the applied adhesive and the housing 8 serving as the bottom 22 of the hole 21. The first clearance L1 and the second clearance L2 have a relationship that first clearance L1≥second clearance L2.

Next, the lens unit 1 is attached, while a video that has been output by using the output mechanism of the second housing 3 is being checked, and a six-axis adjuster is adjusting six axes, optical axis adjustment (X/Y), a focusing position (Z), and a tilt (θX/θY/θZ), of an imaging module. Specifically, the lens unit 1 and the first housing 2 in which the adhesive member 9 has been formed in advance are brought close to each other to have a specified value.

Next, the lens unit 1 is moved in the Z-axis direction (an optical axis direction of the lens 12), peaks of a modulation transfer function (MTF) on an optical axis, at the center, and in the periphery are searched for, and an adjustment position is determined according to calculation values (adjustment of the focusing position). Next, position correction is performed in an XY-direction (a direction that is orthogonal to the optical axis direction of the lens 12), and optical axis adjustment is performed.

Next, a positional relationship between the optical axis direction of the lens 12 and the imaging element 41 is tilted, and the tilt (θX/θY/θZ) is adjusted. Note that the order of optical axis adjustment is not limited to the order described above. Furthermore, parameters to be used in optical axis adjustment are not limited to six axes.

After six-axis adjustment has been completed, the adhesive is cured in two stages, and the lens unit 1 is fixed to the housing 8. In this case, the adhesive is cured after two stages of processes, first curing using UV irradiation and second curing using heat treatment.

Specifically, first, UV irradiation is performed on an adhesive that has been applied to a joining portion between the lens barrel 11 and the first housing 2. As a result of this, an adjusted positional relationship between the imaging element 41 and the lens unit 1 is temporarily fixed. Next, heat treatment is performed on the adhesive after first curing, and therefore second curing is performed. In general, it is desirable that heat treatment be performed for five minutes or more in a device that has been heated to 70° C. or higher.

This causes the lens unit 1 to be more firmly mounted on the first housing 2. By performing two-stage curing on an adhesive, as described above, the imaging device 100 can secure enough strength to be resistant to an impact made during vehicle traveling without displacement of the optical axis that has been positioned in advance. Note that the adhesive may adhere by only performing first curing using UV irradiation.

Meanwhile, the imaging device 100 described above is installed outside the vehicle in some cases. If the imaging device 100 is installed outside the vehicle, for example, liquid, such as raindrops, that has been generated in a variety of environments (for example, high temperature and humidity) sticks to the imaging device 100, and the liquid enters the adhesive member 9, there is a possibility that the adhesive member 9 will expand.

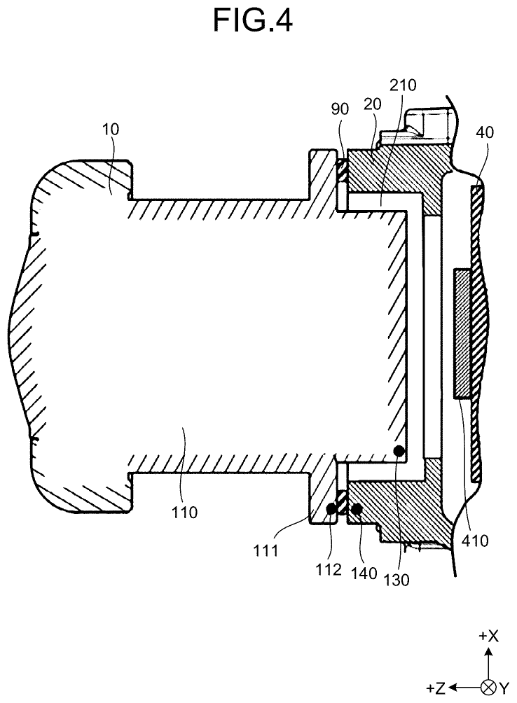

Here, the imaging device 100 according to the present embodiment is described in comparison with a conventional example with reference to FIG. 4. FIG. 4 is a sectional view illustrating an example of an imaging device in the conventional example. As illustrated in FIG. 4, in the imaging device in the conventional example, a case is assumed where in a state where one end side 130 of a lens barrel 110 of a lens unit 10 has been fitted into a hole 210 provided in a first housing 20, an adhesive member 90 has been applied and cured between an end 112 on a side of a board 40 on one end side of a flange 111 provided in a circumferential direction of the lens barrel 110 and an upper face 140 of the first housing 20.

In the case of the configuration of FIG. 4, if liquid sticks to the cured adhesive (the adhesive member 90), the adhesive member 90 expands in a +− direction of the X-axis, a +− direction of the Y-axis, and a + direction of the Z-axis. Here, focusing on X-axis and Y-axis directions, a side face in an outer peripheral direction and a side face in an inner peripheral direction of the adhesive member 90 are free. Therefore, the adhesive member 90 roughly equally expands in the +− direction of the X-axis and the +− direction of the Y-axis, and does not move the lens barrel 110 in the X-axis direction and the Y-axis direction. Stated another way, displacement (center deviation) in an XY-axis direction of the lens barrel 110 relative to the first housing 20 does not occur.

On the other hand, focusing on the Z direction, the adhesive member 90 abuts onto the end 112 on the side of the board 40 on the one end side of the flange 111 provided in the circumferential direction of the lens barrel 110 and the upper face 140 of the first housing 20. Therefore, the adhesive member 90 that liquid has stuck to expands in an optical axis direction (the + direction of the Z-axis) of the lens barrel 110, and pushes the lens barrel 110 up in the + direction of the Z-axis relative to the first housing 20, and therefore deviation occurs in an optical positional relationship between the lens barrel 110 and an imaging element 410, and it is difficult to maintain an appropriate positional relationship between the first housing 20 and the lens barrel 110. In this case, image quality deteriorates, for example, such that a captured image is out of focus.

In contrast, in the imaging device 100 according to the present embodiment, the lens barrel 11 is fitted into the hole 21 in a state where the end 13 on one end side of the lens barrel 11 is separated from the housing 8. Furthermore, the adhesive member 9 is provided between the outer peripheral surface of the lens barrel 11 and the inner peripheral surface of the hole 21 in a state where one end side of the lens barrel 11 has been fitted into the hole 21.

In this case, even if liquid sticks to the adhesive member 9 and the adhesive member 9 expands, the adhesive member 9 is provided between the outer peripheral surface of the lens barrel 11 and the inner peripheral surface of the hole 21, and therefore the adhesive member 9 does not expand in the XY-axis direction. Accordingly, displacement (center deviation) in the XY-axis direction of the lens barrel 11 relative to the first housing 2 does not occur.

Furthermore, in the imaging device 100 according to the embodiment, an end 14 on a side of the board 4 and another end 15 in the adhesive member 9 are free. Therefore, even if the adhesive member 9 expands, the adhesive member 9 equally expands in the optical axis direction (the positive and negative directions of the Z-axis), and does not move the lens barrel 11 in the optical axis direction (the positive and negative directions of the Z-axis). Therefore, in the imaging device 100 according to the present embodiment, an optical positional relationship between the lens barrel 11 and the imaging element 41 can be maintained in an appropriate state. In this case, image quality does not deteriorate, for example, such that a captured image is out of focus.

Furthermore, in the imaging device 100 according to the present embodiment, the end 13 on the one end side of the lens barrel 11 is fitted into the hole 21 in a state where the end 13 is separated from the housing 8, and the adhesive member 9 is provided in a portion where the outer peripheral surface of the lens barrel 11 faces the inner peripheral surface of the hole 21. Therefore, even if the adhesive member 9 expands, the adhesive member 9 does not abut onto the hole 21 in the Z-axis direction, and the adhesive member 9 is not pushed up in the positive direction of the Z-axis direction from the bottom 22 of the hole 21, and is not moved.

Accordingly, a positional relationship between the adhesive member 9 and the hole 21 is appropriately maintained, and therefore a positional relationship between the housing 8 and the adhesive member 9 is also appropriately maintained (the positional relationship does not change in the Z-axis direction). Thus, a positional relationship between the lens barrel 11 and the housing 8 is also appropriately maintained.

As described above, in the imaging device 100 according to the present embodiment, even in a case where the adhesive member 9 that fixes the lens barrel 11 and the housing 8 has expanded, an appropriate positional relationship between the lens barrel 11 and the housing 8 can be maintained.

The imaging device according to the present disclosure is capable of maintaining an appropriate positional relationship between the lens unit and the housing.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imaging device comprising:
a lens barrel in which a lens is arranged;
a board on which an imaging element is mounted, the imaging element converting light received through the lens into an image signal;
a housing that houses the board, the housing including a hole at a position that faces the imaging element, one end side of the lens barrel being fitted into the hole; and
an adhesive member that is provided between an outer peripheral surface of the lens barrel and an inner peripheral surface of the hole, in a state where the one end side of the lens barrel is fitted into the hole, the adhesive member fixing the lens barrel to the housing.

2. The imaging device according to claim 1, wherein
the lens barrel is fitted into the hole in a state where an end on the one end side of the lens barrel is separated from the housing, and
the adhesive member is provided in a portion where the outer peripheral surface of the lens barrel faces the inner peripheral surface of the hole.

3. The imaging device according to claim 1, wherein
the adhesive member is provided in a circumferential direction of the lens barrel.

4. The imaging device according to claim 2, wherein
the adhesive member is provided in a circumferential direction of the lens barrel.

5. The imaging device according to claim 1, wherein
a water absorption rate of the adhesive member is 0.5% or less.

6. The imaging device according to claim 2, wherein
a water absorption rate of the adhesive member is 0.5% or less.

7. The imaging device according to claim 2, wherein
a first clearance is provided between a board-side end of the adhesive member and the housing serving as a bottom of the hole,
a second clearance is provided between the end on the one end side of the lens barrel and the housing serving as the bottom of the hole, and
the first clearance has a size equal to or greater than that of the second clearance.
